(19) United States
(12) Patent Application Publication
(10) Pub. No.: US 2026/0250990 A1
(43) Pub. Date: Aug. 27, 2026

(54) MOTOR VEHICLE LATCH

(71) Applicant: Kiekert Aktiengesellschaft, Heiligenhaus (DE)

(72) Inventor: Robert S. Pettengill, Farmington, MI (US)

(73) Assignee: Kiekert Aktiengesellschaft, Heiligenhaus (DE)

(21) Appl. No.: 19/064,856

(22) Filed: Feb. 27, 2025

(51) Int. Cl. E05B 81/42; E05B 81/04; E05B 81/20; E05B 81/30; E05B 81/34

(52) U.S. Cl. CPC E05B 81/42; E05B 81/04; E05B 81/20; E05B 81/30; E05B 81/34

(57) ABSTRACT

The subject matter of the invention is a motor vehicle latch comprising a locking mechanism having a catch and at least one pawl, wherein a rotational movement of the catch can be locked in at least one ratchet position by means of the pawl; a ratchet element located in the engagement region between the catch and the pawl and pivotably arranged on the catch; a drive device, wherein the locking mechanism can be unlocked by means of the drive device, and wherein the locking mechanism can be transferred from a pre-ratchet position to a main ratchet position by means of the drive device.

The invention relates to a motor vehicle latch comprising a locking mechanism having a catch and at least one pawl, wherein a rotational movement of the catch can be locked in at least one ratchet position by means of the pawl; a ratchet element pivotably arranged on the catch in an engagement region between the catch and the pawl; and a drive arrangement, wherein the locking mechanism can be unlocked by means of the drive arrangement.

To increase the comfort, more and more electrically assisted operating elements are integrated into today's motor vehicles. As an operating element for entering the motor vehicle, what are known as opening apparatuses are used, which position the door towards the operator or vehicle driver such that the door only has to be gripped and completely opened. The opening apparatuses are combined solutions, since an opening apparatus is attached to an electrically actuatable locking system. If the operator approaches the motor vehicle and issues the command to open the door, the motor vehicle latch is opened electrically, and the opening apparatus moves the door towards an opening gap, in the range of approximately 50 mm to 100 mm, relative to the motor vehicle body. As a result, the operator of the motor vehicle is enabled to grip and completely open the door element.

On the one hand, electrically assisted opening can increase the user-friendliness of the vehicle and, on the other, it is possible to do without external control elements, such as an outside door handle. In the case of electrically operable vehicle locks, the locking mechanism is unlocked by means of an electric drive and/or a downstream gear so that the component to be moved on the vehicle is released. Because the locking mechanism is unlocked electrically, mechanical operation, e.g., of the outside door handle and/or an inside door handle, can be dispensed with. This results in both structural and aesthetic advantages in the design of the motor vehicle, which can also result in aerodynamic advantages.

The operator can, for example, issue the entry command using a radio remote control or a chip card, which initiates the unlocking of the locking mechanism. The movable component arranged on the motor vehicle, in particular the side door, is then unlocked and presented to the operator by means of the opening apparatus. The operator simply has to grasp the door and open it wide enough to get into the vehicle. In addition to ease of use, there are also advantages in terms of a potentially smaller number of components for opening the side door, for example, and, as already indicated above, aesthetic advantages in that greater design freedom is given to the designer of the motor vehicle.

An opening apparatus of this kind is known for example from DE 10 2017 124 282 A1. In this case, the opening apparatus has an electric drive and an actuator, wherein the actuator is adjustable by means of the drive, and wherein the motor vehicle door is openable by means of the actuator. In order to be able to monitor the actuating movement, the opening apparatus further has a sensor for detecting the actuating movement, such that a continuous detection of the actuating movement is made possible. The electric drive or the drive unit is formed from an electric motor having a downstream transmission, wherein the actuator itself is driven by a rack-and-pinion drive. During the actuating movement, the sensor is in continuous operation. In contrast, if the moving door element is gripped and opened by the operator, the switching signal of the sensor is lost, and the actuating means are moved back into the initial position.

A further opening apparatus is known from DE 10 2018 132 665 A1. This opening apparatus also has an electric drive and an actuator, wherein the actuator is adjustable by means of the drive and a transmission arranged between the actuator and the drive. In addition, there is the possibility that the door element can be held by means of the actuator. In order to detect a manual actuation of the door element, a force measuring device is used, which initiates a release of the actuator from the door element in the event of an increased load on the door element.

From DE 10 2020 124 099 A1, an opening apparatus for a motor vehicle door element has become known, wherein the opening apparatus interacts with an electrically unlockable locking mechanism. The opening apparatus has an electric drive and an opening element acting upon the door element, wherein the opening element is adjustable by means of the electric drive and a gear arranged between the electric drive and the actuating element, so that the door element can be opened by means of the opening element and wherein a discontinuous transmission ratio can be made possible by means of a gear. By means of the transmission ratio of the gear, large forces can be introduced into the opening element. This makes it possible to have sufficient force to open the door element even if the door seal or latch is frozen.

As already explained in the introduction, comfort can be increased by dispensing with mechanical, i.e., manual, unlocking of the locking mechanism. Electrical unlocking increases convenience in that the operator has only to give an opening command to open a side door or a tailgate, for example. In combination with the opening apparatus, the vehicle door or tailgate can then be presented to the operator for grasping.

In order to facilitate electrical opening and to provide a motor vehicle latch that is easy to open, it has become known from DE 10 2018 126 165 A1 to arrange a ratchet element in the locking mechanism. The document discloses a motor vehicle latch, in particular an electrically operable motor vehicle latch, comprising a locking mechanism having a catch and at least one pawl, wherein it is possible to ratchet the catch in at least one main ratchet position by means of the pawl, and a further ratchet element located between the catch and the pawl in the engagement region and pivotably arranged on the catch. During electrical unlocking, a release lever acts upon the pawl and moves the pawl away from the catch. When the pawl is pivoted, the ratchet element rolls between the catch and the pawl, allowing easy unlocking. The rolling movement between the catch and the pawl takes place at the time when the greatest possible closing force is present between the locking mechanism parts, so that the high closing force is released by means of a rolling movement and thus smoothly.

The solutions known from the prior art for opening a door element have generally proven to be effective. In addition, the automotive industry is always striving to develop more compact, structurally simpler, and therefore more cost-effective motor vehicle latches that increase comfort for the operator. This is where the invention starts.

The object of the invention is to provide an improved motor vehicle latch. In particular, it is an object of the invention to provide a motor vehicle latch that has a compact design and at the same time provides a high level of functionality with the smallest possible number of components.

According to the invention, the object is achieved by the features of independent claim 1. Advantageous embodiments of the invention are specified in the dependent claims. It should be noted that the exemplary embodiments described below are not restrictive; rather, any variation of the features described in the description and the dependent claims is possible.

The object of the invention is achieved in that a motor vehicle latch comprising a locking mechanism having a catch and at least one pawl is provided, wherein a rotational movement of the catch can be locked in at least one ratchet position by means of the pawl; a ratchet element located in the engagement region between the catch and the pawl and arranged pivotably on the catch; a drive device, wherein the locking mechanism can be unlocked by means of the drive device, and wherein the locking mechanism can be transferred from a pre-ratchet position to a main ratchet position by means of the drive device. The construction of the motor vehicle latch according to the invention now makes it possible to provide a compact motor vehicle latch having a small number of components and a high level of functionality using the smallest possible number of components, viz., with the aid of the drive device for closing. In particular, the use of the drive device for transferring the locking mechanism from a pre-ratchet position to a main ratchet position makes it possible to dispense with further electric drives for closing. When closed, the component pivotably located on the motor vehicle is transferred from a pre-ratchet closing position-the pre-ratchet-to a main ratchet closing position-the main ratchet. Typically, the drive device moves the locking mechanism from the pre-ratchet position into an overstroke position so that the pawl can be safely engaged. Only after the pawl has engaged does the locking mechanism reach its final locked position-the main ratchet position. What is essential to the invention is that the drive device for unlocking the locking mechanism is also used to close it, so that further electric drives can be dispensed with.

The opening movement and the closing movement can initiate a movement in the door element by means of the motor vehicle latch according to the invention, so that the operator is faced with a fully automatic door or door element. If, for example, an icy door can be broken open by means of the opening apparatus, as is known from the prior art, a door that is ajar or in a pre-ratchet position can be transferred to a main ratchet position by means of the closing device.

The motor vehicle latch has an electrically unlockable locking mechanism. Electrical unlocking means that a locking mechanism in a ratchet position can be electrically moved into a release position, i.e., an unlocked position. The catch is preferably moved by interaction with a latch holder and, when the door element is closed, comes into a first ratchet position, which is referred to as the pre-ratchet position, wherein, in the pre-ratchet position, the spring-loaded pawl comes into engagement with the catch or the ratchet element. If the interaction between the catch and the latch holder causes the catch to move further towards the closed position, the pawl can engage in the main ratchet position of the catch. In this main ratchet position, the door element is in the closed position. If the pawl is now disengaged from the catch, e.g., by means of an electric drive and a downstream one-, two-, or multi-stage gear, the catch can move freely and release the latch holder. The electric drive then unlocks the locking mechanism, and the door element is released. By means of the closing function added according to the invention, the transfer of the locking mechanism from the pre-ratchet position to the main ratchet position can also be carried out with electrical assistance.

The electrical closing mechanism moves the locking mechanism from the pre-ratchet position to the main ratchet position. For this purpose, a mechanism can act upon the catch and introduce a force into the catch, which moves the catch from the pre-ratchet position to the main ratchet position. Large forces must be overcome to move the catch into the main ratchet position. The door element, which can be a side door of a motor vehicle, for example, is moved against the force of a door seal. In order to allow the door element to close completely, the sealing rubber between the door element and the body must be compressed, i.e., compacted, all the way around. Depending upon the size of the door, a great deal of force may be necessary. The closing device must introduce this force into the locking mechanism in order to achieve the main ratchet position and thus the closed position of the door element. If the door element is in the closed position, the locking mechanism can be unlocked electrically according to the invention.

Electrical unlocking of the locking mechanism requires that the locking mechanism be disengaged from the catch by means of an electric drive and a downstream gear. If the locking mechanism is unlocked, the door element can be moved from the closed position to the open position using the opening apparatus. The open position is characterized by the fact that the door element can move freely from the locking mechanism, and thus from being held in place by the motor vehicle latch. The opening apparatus can move the door element enough to release the catch from the latch holder. In any case, the door element must be able to move sufficiently to allow an operator to grasp the door element and open the door element in order to enter or exit the motor vehicle. The opening apparatus preferably has an actuating element, wherein the actuating element can be moved out of the door element and is supported, for example, on a B-pillar of the motor vehicle. By moving the adjusting element, the door element can be moved-preferably pivoted.

When reference is made to a door element according to the invention, this preferably includes side doors of motor vehicles. However, the invention is not limited to side doors, but can also be used, for example, in hoods, flaps, sliding doors, or covers-in other words, wherever door elements arranged on the motor vehicle in a pivoting or sliding manner must be held securely in a position by means of a motor vehicle latch during use of the motor vehicle.

An operator can now use the open position of the motor vehicle door element, and the gap between the motor vehicle door and the motor vehicle body created in the process, in order to grip the motor vehicle door element through this gap, completely or in part, in the course of the manual opening process. In this case, whether the motor vehicle door element is designed as, for example, a motor vehicle side door or tailgate is immaterial in principle. In this way, even motor vehicle door elements which are designed as sliding doors can be opened far enough that they can be subsequently opened completely by the manual opening process.

The electric drive is preferably a direct current motor, which interacts directly or indirectly with the transmission. It is conceivable here that, for example, a gearwheel arranged on a drive shaft of the electric motor, for example a worm gear, can be brought into engagement with a gear wheel or a toothing on the transmission. The gear wheel then likewise forms part of the transmission and can be referred to as a preliminary stage, for example. However, it is also conceivable that the transmission acting upon the actuator can be actuated by means of a Bowden cable. For this purpose, for example the electric drive can be arranged at a distance from the actuator or transmission, in the motor vehicle, and drive the transmission via the Bowden cable and, for example, a gear preliminary stage.

The opening apparatus is used with an at least electrically releasable motor vehicle lock. If the operator gives the opening command, wherein for example a touch-sensitive switch is provided on the motor vehicle, or a radio remote control is actuated, a locking mechanism in the motor vehicle lock is initially electrically unlocked by means of a control unit in the motor vehicle, wherein a pawl of a locking mechanism releases the rotary latch, such that a lock striker held by the rotary latch is released. After the electrical unlocking, the door element is freely movable. After unlocking, the opening apparatus is activated, and the door element is transferred by the opening apparatus from the closed position into the open position. The open position is characterized in that an opening gap is present between the door element and the vehicle body, into which an operator can grip and completely open the door element.

In an advantageous further development of the invention, the drive device has a closing lever, wherein the closing lever can be brought into engagement with the catch. The drive device is able to unlock the locking mechanism. In addition, the drive device can be used to move the catch from the pre-ratchet position to an overstroke, and ultimately to a main ratchet position. By means of the closing lever arranged in the drive device, the drive device can engage directly in the catch and introduce a force into the catch. The use of a separate closing lever has the advantage that a favorable force ratio can be provided via a lever ratio.

In continuation of the inventive concept, it can be advantageous if the closing lever can be mounted in an operating lever of the drive device. The drive device has an operating lever that is able to initiate unlocking of the locking mechanism and to move the locking mechanism into an open position. In addition, the operating lever serves as a means of closing, meaning that the operating lever has a dual function. Combining a plurality of functions into one lever allows for a compact design and a reduced number of components for high functionality in the motor vehicle latch. If the closing lever is now also mounted in the operating lever, there is no need for an additional bearing point for the closing lever in the motor vehicle latch. In addition to the compact installation space, this also allows the overall weight of the motor vehicle latch to be reduced.

As a preferred embodiment, it has been found that it can be advantageous if a movement of the closing lever can be guided by means of a control cam. The closing lever, also called the closing pawl, is guided by the control cam in a path that allows the closing lever to be controlled or moved into the movement range of the catch. This creates a structurally simple possibility to use the operating lever for a plurality of functions. By moving the operating lever, the closing lever or the closing pawl comes into engagement with the catch or can be swung out of the movement range of the catch. This makes it possible to control when the catch moves freely and in which region the closing lever can engage with the catch. The control cam is preferably arranged in a fixed position in the motor vehicle latch and on the motor vehicle latch housing. Depending upon the arrangement of the closing pawl on the operating lever, it can be advantageous if a bolt-like extension is formed on the closing lever, wherein the bolt can be brought into engagement with the control cam, so that, on the one hand, a free pivoting region can be provided for the closing pawl and, on the other, a secure interaction between the closing lever or bolt and the control cam can be ensured.

In a further advantageous embodiment, the operating lever is pivotably accommodated on a locking mechanism part shaft, in particular the catch shaft. In order to increase compactness while maintaining functionality, the operating lever can be mounted on a locking mechanism part shaft. The operating lever can be arranged in an advantageous manner about the shaft of the catch in order, on the one hand, to reach the catch easily and safely for closing and, on the other, there is the possibility of accessing the pawl. The locking mechanism part axles are preferably made of a metal material, in particular steel, and are firmly received in the latch case, which is also made of a metal material. In addition, the locking mechanism part shafts can be accommodated in a reinforcement plate and/or in the latch housing. The locking mechanism is mounted in metal in particular in order to be able to absorb the high tensile forces that must be absorbed for safety reasons and in accordance with legal regulations. By using the locking mechanism part shaft as a bearing point for the operating lever, a stable bearing point is provided so that even the high forces required for closing can be transmitted safely.

In one embodiment of the invention, by means of a movement of the operating lever, a transfer into a main ratchet position is possible, and, by means of a movement in an opposite direction, an unlocking of the locking mechanism is possible. The operating lever is preferably pivotably accommodated and electrically driven in the motor vehicle latch. By means of the drive unit, the operating lever can be driven in different directions. If the operating lever is used to unlock the locking mechanism, and thus as a release lever, and at the same time the closing lever can be brought into engagement with the catch by means of the operating lever, a high level of functionality can be ensured with a compact design. Moving in different directions, i.e., switching the direction of movement, can be used to initiate the unlocking of the locking mechanism on the one hand and to allow the catch to be moved from the pre-ratchet position to the main ratchet position on the other. A toothing can be arranged on the operating lever itself, which toothing can be brought into engagement with the electric drive of the drive device. The engagement between the electric drive and the operating lever can be indirect, so that one, two, or more gear stages can be arranged between the electric motor and the operating lever, but it is also conceivable that transmission means, such as a lever mechanism, be used to drive the operating lever.

In a further development of the invention, the ratchet element can be actuated directly or indirectly by means of the operating lever. As already described above, the operating lever can be used as a release lever. If the ratchet element arranged between the catch and the pawl is actuated by means of the operating lever, the pawl can be indirectly actuated. The pawl locks the locking mechanism and is pivotably mounted in the latch case at a distance from the catch. The motor vehicle latch according to the invention has a ratchet element that is pivotably mounted in the catch and engages with the pawl at least in the main ratchet position. If the operating lever itself now acts upon the ratchet element, the rolling movement between the ratchet element and the pawl described above can be initiated by the operating lever. It is consequently possible to open the locking mechanism with ease. In the case of indirect actuation of the ratchet element, for example, a coupling lever pivotably mounted in the motor vehicle latch can interact with a control contour on the operating lever.

In order to further increase the functionality of the motor vehicle latch, the operating lever can be used to move a door element from a closed position to an open position. The operating lever thus serves as an additional opener for a door element that is pivotably or slidably mounted on the motor vehicle. In addition to unlocking and closing the locking mechanism, the operating lever in this embodiment also takes on the function of an opener. It is advantageous to arrange the operating lever on a bearing point of the locking mechanism components, as this provides a central point of attack for the operating lever. Preferably, the operating lever can be brought into engagement with a latch holder. A direct interaction between the operating lever and the latch holder makes it possible, with a minimal number of components and via the central functional element of the operating lever, to realize a plurality of functionalities in the motor vehicle latch. If the motor vehicle latch has been unlocked by the operating lever, the operating lever itself can be used to move the door element into the open position as the movement of the operating lever continues. Starting from the closed position, with the locking mechanism unlocked, the operating lever can then move the door element and allow it to be opened in extreme situations, such as when breaking ice. Ice breaking occurs when, due to weather conditions, the door element does not move out of the main ratchet position on its own, but remains in the closed position due, for example, to an icy door seal. In this case, the door element can be moved into an open position by means of the opener or in this case the operating lever, and the ice between the door seal and the door element can be broken. The operator is then able to grasp the door element and open it completely.

The inventive design of the motor vehicle latch and in particular the advantageous design variants make it possible to provide a compact motor vehicle latch having a high level of functionality. If closing, i.e., transfer to the overstroke and main ratchet position, can take place, easy opening can be initiated by actuating the locking element and, in addition, the door element can be presented to the operator in the open position. Only one drive device is required for this, such that the costs are also reduced to a minimum.

The invention is explained in more detail below with reference to the accompanying drawings on the basis of a preferred exemplary embodiment. However, the principle applies that the exemplary embodiment does not limit the invention, but is merely an advantageous embodiment. The features depicted can be implemented individually or in combination with further features of the description as well as what is claimed-individually or in combination.

In the figures:

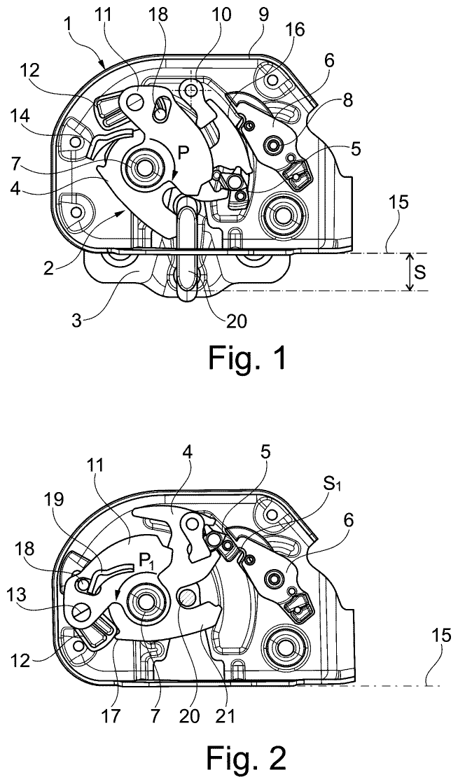

FIG. 1 is a plan view of a motor vehicle latch equipped according to the invention, wherein only the components essential for explaining the invention are shown and wherein an open position of the door element or the motor vehicle latch is shown.

FIG. 2 is a plan view of the motor vehicle latch according to FIG. 1, wherein the motor vehicle latch is shown in an overstroke position at the end of a closing process, and

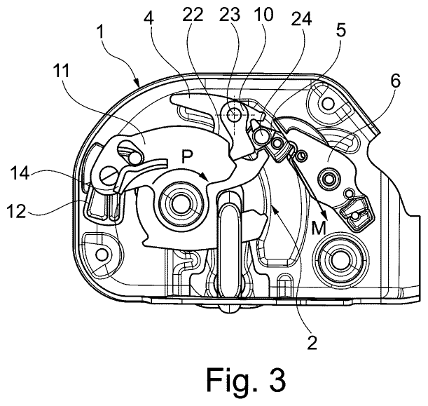

FIG. 3 shows the motor vehicle latch according to the invention as shown in FIG. 1 in a main ratchet position.

FIG. 1 shows a motor vehicle latch 1 in an open position. The motor vehicle latch 1 comprises a locking mechanism 2, wherein the locking mechanism engages with a latch holder 3. The locking mechanism 2 comprises a catch 4, a ratchet element 5, and a pawl 6. The locking mechanism components catch 4 and pawl 6 are each accommodated in a latch case 9 so as to be pivotable about a locking mechanism part shaft 7, 8. A coupling lever 10 is pivotably mounted in a motor vehicle latch housing (not shown), wherein the coupling lever 10 rests against an operating lever 11 in a spring-loaded manner. A closing lever 12 is arranged on the operating lever 11, wherein the closing lever is accommodated in the operating lever 11 so as to be pivotable about the closing lever shaft 13. The closing lever 12 can be brought into engagement with a control contour 14 so that the closing lever can be pivoted in the direction of the catch 4.

FIG. 1 shows the open position of a door element, wherein the open position is represented as gap S in FIG. 1. The open position of the door element 15 can be achieved, for example, by means of the operating lever 11 by moving the operating lever 11 in the direction of the arrow P-clockwise in FIG. 1—or by driving it by means of the drive device. In this case, the operating lever 11 acts as a support for the door element 15.

The locking mechanism 2 is shown in an open position. The pawl 6 rests against a contact contour 16, i.e., an outer contour 16 of the catch 4, in a spring-loaded manner. Starting from the shown open position of the door element 15, it is possible for the operator to grasp the door element and pivot it completely-for example, to get into the motor vehicle.

FIG. 2 shows the overstroke position of the catch 4, which is reached when the operating lever 11 has been moved counterclockwise about the shaft 7 in the direction of the arrow P1. After closing the door element 15, the locking mechanism 2 moves into a pre-ratchet position and is then moved into the overstroke position by means of the closing lever 12. For this purpose, the closing lever engages a stop surface 17 and moves the catch anti-clockwise about the locking mechanism part shaft 7. In the transition from FIG. 1 to FIG. 2, it can be seen that a bolt 18 engages with a control contour 19, whereby the closing lever 12 is moved counterclockwise about the closing lever shaft 13, so that the closing lever or the closing pawl 12 engages with the stop surface 17 on the catch 4. When the operating lever 11 is moved in the direction of the arrow P, i.e., counterclockwise, the operating lever 11 acts as a closing mechanism for the locking mechanism 2. When the overstroke position is reached, the pawl 6 can securely engage with the ratchet element 5, wherein the overstroke position has been illustrated by the gap S1 in FIG. 1. In this position, the latch holder bracket 20 rests on the load 21 of the catch. The position of the motor vehicle latch 1 shown in FIG. 2 shows the position of the motor vehicle latch 1 or the door element 15, in which the door element 15 is moved against a door seal into the motor vehicle body.

FIG. 3 shows the motor vehicle latch 1 in a closed position, i.e., a main ratchet position of the locking mechanism 2. It can be seen that the closing lever 12 is held at a distance from the catch 4 by means of the control contour 14, so that the catch 4 can move independently of the closing lever 12. The ratchet element 5 rests on the pawl 6 and holds the motor vehicle latch 1 in the closed position. In this closed position, a closing moment M occurs in the locking mechanism 2, so that a secure locking of the motor vehicle latch 1 can be ensured. If the operating lever 11 is now moved in the direction of the arrow P, the coupling lever 10 engages with a control contour 22 on the operating lever 11. The control contour 22 causes the coupling lever 10 to be moved counterclockwise about the shaft 23 and to engage with a cylindrical extension 24 on the ratchet element 5. The actuation of the ratchet element 5 causes the ratchet element to pivot in the catch receptacle 4 and, at the same time, the ratchet element 5 to roll on the pawl 6. The rolling movement in the locking mechanism 2 means that the main load from the door seal is transferred to the latch holder or the motor vehicle latch 1, so that, when the ratchet element 5 is separated from the pawl, only small forces act, so that a quiet separation of the ratchet element 5 from the pawl 6 is possible.

The inventive design of the motor vehicle latch 1 makes possible a plurality of functions, such as closing, locking, and unlocking, in a compact design, while at the same time being able to work with the smallest possible number of components in order to achieve a high level of functionality.

### LIST OF REFERENCE SIGNS

1 Motor vehicle latch
2 Locking mechanism
3 Latch holder
4 Catch
5 Ratchet element
6 Pawl
7,8 Locking mechanism part shaft
9 Latch case
10 Coupling lever
11 Operating lever
12 Closing lever
13 Closing lever shaft
14, 19, 22 Control contour
15 Door element
16 Contact contour
17 Stop surface
18 Bolt
20 Latch holder bracket
21 Load arm
23 Axis
24 Cylindrical extension
S, S1 Gap
P, P1 Arrow
M Moment, force

1. A motor vehicle comprising:
a locking mechanism having a catch, at least one pawl, with an engagement region between the catch and the at least one pawl,
wherein a rotational movement of the catch is configured to be locked in at least one ratchet position by the pawl;
a ratchet element located in the engagement region, the ratchet element pivotably arranged on the catch; and
a drive device, wherein the locking mechanism is configured to be unlocked by the drive device, and
wherein the locking mechanism is configured to be transferred from a pre-ratchet position to a main ratchet position by the drive device.

2. The motor vehicle latch according to claim 1, wherein the drive device has a closing lever, wherein the closing lever is configured to be brought into engagement with the catch.

3. The motor vehicle latch according to claim 2,
wherein the drive device includes an operating lever, and
wherein the closing lever is mounted in the operating lever of the drive device.

4. The motor vehicle latch according to claim 2, further comprising a control cam, wherein a movement of the closing lever is guided by the control cam.

5. The motor vehicle latch according to claim 3, further comprising a locking mechanism part shaft, wherein the operating lever is pivotably accommodated on the locking mechanism part shaft.

6. The motor vehicle latch according to claim 3,
wherein, by movement of the operating lever, the locking mechanism is configured to be transferred into a main ratchet position, and
wherein the locking mechanism is further configured to be unlocked by a movement of the operating lever in an opposite direction.

7. The motor vehicle latch according to claim 3, wherein the ratchet element is configured to be operated indirectly or directly by the operating lever.

8. The motor vehicle latch according to claim 3,
wherein the motor vehicle includes a door element, and
wherein a transfer of the door element from a closed position to an open position is configured to be achieved by the operating lever.

9. The motor vehicle latch according to claim 3, further comprising a latch holder, wherein the operating lever is configured to be brought into engagement with the latch holder.

10. The motor vehicle latch according to claim 3,
wherein the drive device includes a gear, and
wherein the operating lever is configured to be driven directly or indirectly by the gear.

11. The motor vehicle latch according to claim 3, wherein the operating lever is configured to initiate unlocking of the locking mechanism and to move the locking mechanism into an open position.

12. The motor vehicle latch according to claim 4, wherein the control cam is configured to guide the closing lever into a movement range of the catch.

13. The motor vehicle latch according to claim 12, wherein the closing lever is configured to be swung out of the movement range of the catch by a movement of the operating lever.

14. The motor vehicle latch according to claim 4, wherein the closing lever is configured to come into engagement with the catch by a movement of the operating lever.

15. The motor vehicle latch according to claim 4,
wherein the closing lever includes a bolt-like extension, and
wherein the bolt-like extension is configured to be brought into engagement with the control cam such that a free pivoting region is formed for the closing pawl. and a secure interaction between the bolt-like extension of the closing lever and the control cam is ensured.
